(19) United States
(12) Patent Application Publication
(10) Pub. No.: US 2026/0197719 A1
(43) Pub. Date: Jul. 9, 2026

(54) COMMUNICATION METHOD IN A COMMUNICATION SYSTEM

(71) Applicant: SAMSUNG ELECTRONICS CO., LTD., Suwon-si, Gyeonggi-do (KR)

(72) Inventors: Fanhua KONG, Beijing (CN); Weiwei WANG, Beijing (CN); Lixiang XU, Beijing (CN); Hong WANG, Beijing (CN)

(21) Appl. No.: 18/996,540

(22) PCT Filed: Jun. 29, 2023
(86) PCT No.: PCT/KR2023/009158

§ 371 Date: Jan. 17, 2025

(30) Foreign Application Priority Data
Aug. 1, 2022 (CN) 202210918024.X

(51) Int. Cl. H04W 36/00; H04L 9/08

(52) U.S. Cl. CPC H04W 36/0055; H04L 9/0838

(57) ABSTRACT

The disclosure relates to a 5G or 6G communication system for supporting a higher data transmission rate. Embodiments of the disclosure provide a communication method, a source IAB donor centralized unit and a target IAB donor centralized unit. The method comprises: receiving a first request message transmitted by a source IAB donor centralized unit, the first request message being configured for requesting for UE context handover; and transmitting a UE context handover command to a user equipment (UE). In accordance with this solution, during a UE context handover process, a UE context handover command is transmitted to the UE through a target IAB donor centralized unit, so that the UE context handover command can still be transmitted to the UE when the migrating node is disconnected from the source IAB donor centralized unit, and thus the context handover of the UE is realized.

### TECHNICAL FIELD

This disclosure relates to wireless communication networks, and more particularly to a terminal and a communication method thereof in a wireless communication system and in particular to a communication method, a source IAB donor centralized unit and a target IAB donor centralized unit.

### Background Art

5G mobile communication technologies define broad frequency bands such that high transmission rates and new services are possible, and can be implemented not only in “Sub 6GHz” bands such as 3.5GHz, but also in “Above 6GHz” bands referred to as mm Wave including 28GHz and 39GHz. In addition, it has been considered to implement 6G mobile communication technologies (referred to as Beyond 5G systems) in terahertz (THz) bands (for example, 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

An objective of the disclosure is to solve at least one of the above technical defects. Embodiments of the disclosure employ the following technical solutions.

In accordance with one aspect of the embodiments of the disclosure, a method performed by a target IAB donor centralized unit in a communication system is provided, including:
receiving a first request message transmitted by a source IAB donor centralized unit, the first request message being configured for requesting for UE context handover; and
transmitting a UE context handover command to a user equipment (UE).

Optionally, the method further includes:
transmitting a first request acknowledgement message carrying first indication information to the source IAB donor centralized unit, the first indication information containing information for indicating that a migrating node is disconnected from the source IAB donor centralized unit.

Optionally, the method further includes:
receiving a second request message transmitted by the migrating node, the second request message being configured for requesting for migration of the migrating node to the target donor centralized unit.

Optionally, the transmitting a UE context handover command to a UE includes:
transmitting a packet data convergence protocol data unit (PDCP PDU) to the UE, the PDCP PDU containing the UE context handover command.

Optionally, the method further includes:
receiving the PDCP PDU transmitted by the source IAB donor centralized unit.

Optionally, the transmitting a UE context handover command to a UE includes:
transmitting the UE context handover command to the UE based on a first security key of the source IAB donor centralized unit.

Optionally, the method further includes:
receiving second indication information transmitted by the source IAB donor centralized unit, the second indication information containing at least one of the first security key and information for instructing the target IAB donor centralized unit to transmit the UE context handover command to the UE based on the first security key.

Optionally, the first request message carries third indication information;
wherein the third indication information contains at least one of:
information for indicating that the migrating node is disconnected from the source IAB donor centralized unit;
the first security key; and
information for instructing the target IAB donor centralized unit to transmit the UE context handover command to the UE based on the first security key.

Optionally, the method further includes:
receiving a third request message carrying third indication information transmitted by the source IAB donor centralized unit, the third request message being configured for requesting for UE context handover;
wherein the third indication information contains at least one of:
information for indicating that the migrating node is disconnected from the source IAB donor centralized unit;
the first security key; and
information for instructing the target IAB donor centralized unit to transmit the UE context handover command to the UE based on the first security key.

Optionally, the first request acknowledgement message further carries fourth indication information, and the fourth indication information is configured for instructing the source IAB donor centralized unit to establish a second F1 connection with a corresponding target IAB donor distributed unit.

Optionally, the transmitting a UE context handover command to a UE includes:
transmitting the UE context handover command to the UE through the target IAB donor distributed unit.

Optionally, the method further includes:
transmitting fifth indication information to the corresponding target IAB donor distributed unit;
wherein the fifth indication information contains at least one of:
trigger information for the target IAB donor distributed unit to establish the second F1 connection with the source IAB donor centralized unit; and
a mapping relationship between the second F1 connection and the first F1 connection, the first F1 connection being an F1 connection between the migrating node and the target IAB donor centralized unit.

Optionally, the transmitting a UE context handover command to a UE includes:
transmitting the UE context handover command to the UE based on a second security key of the target IAB donor centralized unit.

Optionally, the method further includes:
receiving a fourth request message transmitted by the source IAB donor centralized unit, the fourth request message being configured for requesting the second security key from the target IAB donor centralized unit; and
transmitting a second request acknowledgement message to the source IAB donor centralized unit, the second request acknowledgement message carrying the second security key, so that the source IAB donor centralized unit transmits sixth indication information to the UE, the sixth indication information being configured for instructing the UE to update a used security key based on the second security key.

Optionally, the sixth indication information contains at least one of:
information for instructing the UE to update the used security key into the second security key when the migrating node is migrated to the target IAB donor centralized unit; and
information for instructing the UE to immediately update the used security key into the second security key.

In accordance with one aspect of the embodiments of the disclosure, a method performed by a source IAB donor centralized unit in a communication system is provided, including:
transmitting a first request message to a target IAB donor centralized unit, the first request message being configured for requesting for UE context handover, so that the target IAB donor centralized unit transmits a UE context handover command to a UE.

Optionally, the method further includes:
configuring a reference signal receiving power/reference signal receiving quality (RSRP/RSRQ) threshold for a migrating node;
receiving an event report transmitted by the migrating node when a measured /RP/ RSRQ of a source parent IAB node is not larger than the RSRP/RSRQ threshold; and
in response to the event report, performing partial migration for migrating node.

In accordance with another aspect of the embodiments of the disclosure, a target IAB donor centralized unit is provided, including:
a transceiver; and
a processor coupled to the transceiver, the processor being configured to control to perform the steps of the method performed by a target IAB donor centralized unit provided by the disclosure.

In accordance with still another aspect of the embodiments of the disclosure, a source IAB donor centralized unit is provided, including:
a transceiver; and
a processor coupled to the transceiver, the processor being configured to control to perform the steps of the method performed by a source IAB donor centralized unit provided by the disclosure.

In accordance with yet another aspect of the embodiments of the disclosure, a computer-readable storage medium is provided, wherein the computer-readable storage medium has computer programs stored thereon that, when executed by a processor, implement the steps of the method executed by a target IAB donor centralized unit provided by the disclosure.

In accordance with yet another aspect of the embodiments of the disclosure, a computer-readable storage medium is provided, wherein the computer-readable storage medium has computer programs stored thereon that, when executed by a processor, implement the steps of the method executed by a source IAB donor centralized unit provided by the disclosure.

In accordance with yet another aspect of the embodiments of the disclosure, a computer program product is provided, including computer programs that, when executed by a processor, implement the steps of the method executed by a target IAB donor centralized unit provided by the disclosure.

In accordance with yet another aspect of the embodiments of the disclosure, a computer program product is provided, including computer programs that, when executed by a processor, implement the steps of the method executed by a source IAB donor centralized unit provided by the disclosure.

In accordance with the solutions provided by the disclosure, during a UE context handover process, a UE context handover command is transmitted to the UE by a target IAB donor centralized unit, so that the UE context handover command can still be transmitted to the UE when the migrating node is disconnected from the source IAB donor centralized unit, and thus the context handover of the UE is realized.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

In order to explain the technical solutions in the embodiments of the disclosure more clearly, the drawings to be used in the description of the embodiments of the disclosure will be briefly illustrated below.

FIG. 1 is an example of a system architecture evolution according to an embodiment of the disclosure;

FIG. 2 is an example of a 5G system architecture according to an embodiment of the disclosure;

FIG. 3 is an example of a base station structure according to an embodiment of the disclosure;

FIG. 4 is a schematic interaction diagram of a context handover process of a UE in an example according to an embodiment of the disclosure;

FIG. 5 is a schematic flowchart of a method performed by a target IAB donor centralized unit in a wireless communication system according to an embodiment of the disclosure;

FIG. 6 is a schematic interaction diagram of encapsulating a UE context handover command into a PDCP PDU in an example according to an embodiment of the disclosure;

FIG. 7 is a schematic interaction diagram of using, by the target IAB donor CU, the first security key of the source IAB donor CU in an example according to an embodiment of the disclosure;

FIG. 8 is a schematic interaction diagram of using, by the target IAB donor CU, the first security key of the source IAB donor CU in another example according to an embodiment of the disclosure;

FIG. 9 is a schematic interaction diagram of establishing a second F1 connection in an example according to an embodiment of the disclosure;

FIG. 10 is a schematic interaction diagram of updating, by the source IAB donor CU, the security key used by the UE in an example according to an embodiment of the disclosure;

FIG. 11 is a schematic interaction diagram of avoiding the occurrence of source link lost in an example according to an embodiment of the disclosure;

FIG. 12 is a schematic interaction diagram of the delay problem caused by UE data reception when DAPS is applied to full migration in an example according to an embodiment of the disclosure;

FIG. 13 is a schematic interaction diagram of providing, by the source IAB donor CU, assistance information to the target IAB donor CU in an example according to an embodiment of the disclosure; and

FIG. 14 is a schematic structure diagram of an electronic device according to an embodiment of the disclosure.

FIG. 15 illustrates a structure of a base station according to an embodiment of the disclosure.

FIG. 16 illustrates a structure of a UE according to an embodiment of the disclosure.

Throughout the drawings, it should be noted that like reference numbers are used to depict the same or similar elements, features, and structures.

### BEST MODE FOR CARRYING OUT THE INVENTION

In order to meet an increasing demand for wireless data communication services since a deployment of the 4th generation (4G) communication system, efforts have been made to develop an improved the 5th generation (5G) or pre-5G communication system. Therefore, the 5G or pre-5G communication system is also called “beyond 4G network” or “post long term evolution (LTE) system”.

Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

In the 5G communication technology, since a higher frequency point is used, a higher transmission speed than 4G is obtained. However, since a higher frequency point will lead to a shorter transmission distance, more base stations will be deployed in the 5G network to ensure the coverage of the 5G network. However, actually, in some areas, the normal deployment of 5G base stations cannot be carried out due to the environment or cost, so an integrated access and backhaul (IAB) technology is proposed to overcome the problem that 5G base stations in these areas cannot be covered and ensure the normal communication of users.

IAB nodes are fixed at the present stage. When the wireless performance of an IAB node is degraded, a source IAB donor centralized unit (source IAB donor CU) can perform partial migration according to the measurement report reported by the IAB node, that is, the RRC signaling of the IAB node is migrated to a target path corresponding to a target IAB donor centralized unit (target IAB donor CU). The IAB nodes further include IAB migrating nodes, and such IAB nodes are also referred to as migrating nodes. If mobility of migrating node is supported in the future, the problem of wireless performance degradation between the migrating node and the donor node may be more serious, and it may be impossible to solve the problem of wireless performance degradation by only performing partial migration to migrate the radio resource control (RRC) signaling of the migrating node to the target path. In this case, an F1 termination also needs to be migrated to the target path, and the context handover of the user equipment (UE) served by the migrating node also needs to be done to realize full migration after the migration of the F1 termination is accomplished.

However, the link between the migrating node and the source IAB donor CU during the migration procedure may be lost (that is, the source link lost occurs), so that the context handover of the UE served by the migrating node cannot be done. Therefore, it is necessary to provide a new UE context handover method.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used in the disclosure, which include technical terminologies or scientific terminologies, have the same meaning as that understood by a person skilled in the art mentioned in the disclosure to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

Before undertaking the description below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the application can be applied to future-oriented communication technologies. In addition, the technical schemes of the embodiments of the application can be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

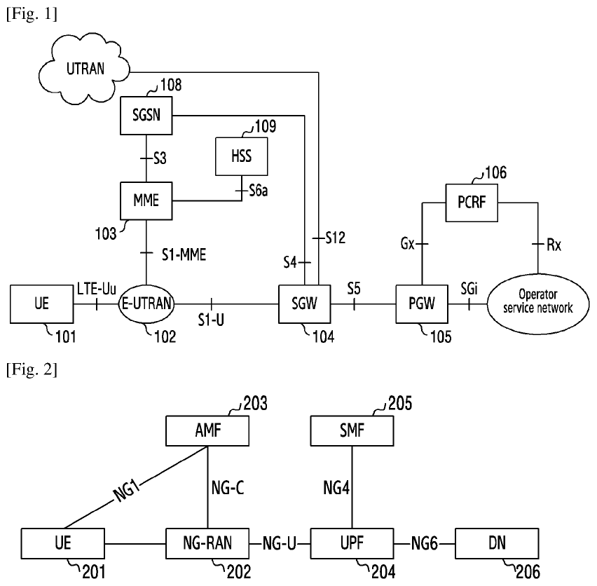

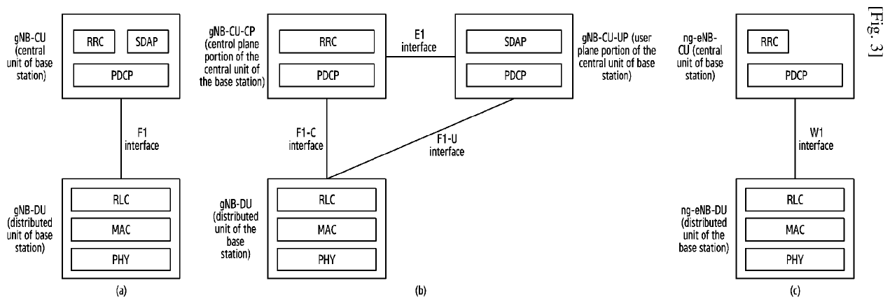

FIGS. 1 to 2 discussed below and various embodiments for describing the principles of the present disclosure in this patent document are only for illustration and should not be interpreted as limiting the scope of the disclosure in any way. Those skilled in the art will understand that the principles of the disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the disclosure. Other embodiments of the system architecture 200 can be used without departing from the scope of the disclosure.

User equipment (UE) 201 is a terminal device for receiving data. A next generation radio access network (NG-RAN) 202 is a radio access network, which includes a base station (a gNB or an eNB connected to a 5G core network (5GC)) that provides the UE with an interface to access a radio network. An access control and mobility management function entity (AMF) 203 is responsible for managing mobility context and security information of the UE. A user plane function entity (UPF) 204 mainly provides a function of user plane. A session management function entity (SMF) 205 is responsible for session management. A data network (DN) 206 includes operators'services, access to Internet, third-party services, etc.

In an NR system, in order to support network function virtualization and more efficient resource management and scheduling, the base station (gNB/ng-eNB) that provides the terminal (UE) with a radio network interface may be further divided into a gNB central unit/ng-eNB central unit (gNB-CU/ng-eNB-CU, referred to as CU for short herein) and a gNB distributed unit/ng-eNB distributed unit (gNB-DU/ng-eNB-DU, referred to as DU for short herein), as shown in diagram (a) in FIG. 3. The gNB-CU has a radio resource control (RRC) layer, a service data adaptation protocol (SDAP) layer, a packet data convergence protocol (PDCP) layer, etc., and the ng-eNB-CU has an RRC layer and a PDCP layer. The gNB-DU/ng-eNB-DU has a radio link control (RLC) protocol layer, a medium access control (MAC) layer, a physical layer, etc. There is a standardized open interface F1 between the gNB-CU and the gNB-DU, and there is a standardized open interface W1 between the ng-eNB-CU and the ng-eNB-DU. The F1 interface is categorized into a control plane F1-C and a user plane F1-U. A transport network layer of the F1-C is based on IP transport. To realize more reliable transmission of signaling, an SCTP protocol is added on top of the IP. The protocol of the application layer is F1AP (see 3GGp TS38.473 ). The SCTP can provide reliable transmission of application layer messages. The transport layer of the F1-U is UDP/IP, and the GTP-U is on top of the UDP/IP and configured for carrying a user plane protocol data unit (PDU). Further, for the gNB-CU, as shown in diagram (b) in FIG. 3, the gNB-CU may include a gNB-CU-CP (a control plane portion of the central unit of the base station) and a gNB-CU-UP (a user plane portion of the central unit of the base station). The gNB-CU-CP contains the function of the control plane of the base station, and has an RRC layer and a PDCP layer. The gNB-CU-UP contains the function of the user plane of the base station, and has an SDAP layer and a PDCP layer. There is a standardized open interface E1 between the gNB-CU-CP and the gNB-CU-UP, and the protocol used therebetween is E1AP (3GPP TS38.463). An interface between the control plane portion of the central unit of the base station and the distributed unit of the base station is an F1-C interface, i.e., a control plane interface of F1. An interface between the user plane portion of the central unit of the base station and the distributed unit of the base station is an F1-U interface, i.e., a user plane interface of F1. In addition, in the NR system, a base station that accesses a 5G core network and provides the E-UTRA user plane and control plane is called the ng-eNB. In order to support virtualization, this base station (ng-eNB) may be further divided into a gNB central unit/ng-eNB central unit (ng-eNB-CU, referred to as CU for short herein) and a gNB distributed unit/ng-eNB distributed unit (ng-eNB-DU, referred to as DU for short herein), as shown in FIG. 3(c). The ng-eNB-CU has an RRC layer and a PDCP layer. The gNB-DU/ng-eNB-DU has a radio link control (RLC) protocol layer, an MAC layer, a physical layer, etc. There is a standardized open interface W1 between the ng-eNB-CU and the ng-eNB-DU. The W1 interface is categorized into a control plane W1-C and a user plane W1-U. The transport network layer of the W1-C is based on IP transport. To realize more reliable transmission of signaling, an SCTP protocol is added on top of the IP. The protocol of the application layer is W1AP (see 3GPP. TS 37.437). The transport layer of the W1-U is UDP/IP, and the GTP-U is on top of the UDP/IP and configured for carrying a user plane protocol data unit (PDU).

The technical solutions in the embodiments of the disclosure and the technical effects achieved by the technical solutions in the disclosure will be explained below by describing several exemplary implementations. It is to be noted that the following implementations can refer to or learn from each other or be combined with each other, and the same terms, similar features and similar implementation steps in different implementations will not be repeated.

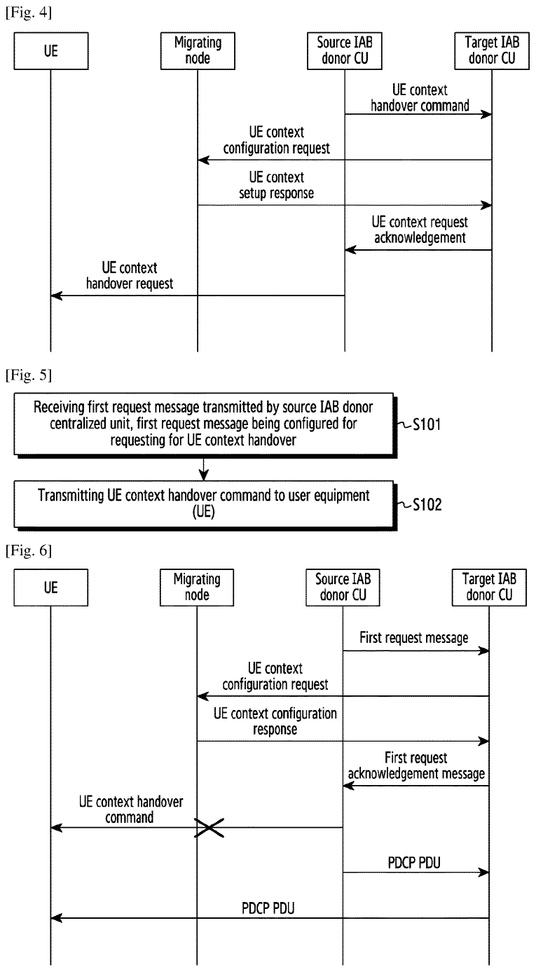

In full migration, the migrating node may be disconnected from a source IAB donor CU during the context handover process of a UE, that is, the source link lost occurs, so that the context handover of the UE cannot be done. Specifically, as shown in FIG. 4, the context handover of the UE under the migrating node may include the following steps.
(1) A source IAB donor CU transmits a UE context handover (HO) request to a target IAB donor CU to request a UE context handover, the UE context HO request containing configuration information configured by the source IAB donor CU for the UE.
(2) The target IAB donor CU transmits a UE context setup request to a migrating node.
(3) The migrating node returns a UE context setup response to the target IAB donor CU.
(4) The target IAB donor CU returns a UE context HO request ACK to the source IAB donor CU, the UE context HO request ACK containing the configuration information configured by the target IAB donor CU for the UE.
(5) The source IAB donor CU transmits a UE context modification or UE context HO command to the UE to update the UE context, so that the UE context is handed over to the target IAB donor CU.

If the source link lost occurs, the step (5) in the above process cannot be performed, that is, the source IAB donor CU cannot transmit the UE context modification to the UE, so that the context handover of the UE cannot be realized. In view of the above problem, the disclosure provides a communication method, a source IAB donor centralized unit and a target IAB donor centralized unit. The implementations of the solutions will be described below in detail.

FIG. 5 is a schematic flowchart of a method performed by a target IAB donor centralized unit in a communication system according to an embodiment of the disclosure. As shown in FIG. 5, the method may include: step S101, receiving a first request message transmitted by a source IAB donor centralized unit, the first request message being configured for requesting for UE context handover; step S102, transmitting a UE context handover command to a UE.

In accordance with the solutions provided by the disclosure, during a UE context handover process, a UE context handover command is transmitted to the UE by a target IAB donor centralized unit, so that the UE context handover command can still be transmitted to the UE when a migrating node is disconnected from a source IAB donor centralized unit, and thus the context handover of the UE is realized.

In one optional embodiment of the disclosure, the method further includes:
transmitting a first request acknowledgement message carrying first indication information to the source IAB donor centralized unit, the first indication information containing information for indicating that a migrating node is disconnected from the source IAB donor centralized unit.

Further, the method further includes: receiving a second request message transmitted by the migrating node, the second request message being configured for requesting for migration of the migrating node to the target IAB donor centralized unit. The second request message may be transmitted through an F1 termination handover request.

Specifically, on one hand, when the source link lost occurs, the migrating node migrates the F1 termination to the target IAB donor CU. At this time, the target IAB donor CU can know the occurrence of source link lost. In specific, the migrating node transmits the second request message to the target IAB donor CU. This request message is configured for requesting the target IAB donor CU for migration of the migrating node to the target IAB donor CU. Upon receiving this request message, the target IAB donor CU knows the occurrence of source link lost. That is, the target IAB donor CU knows the occurrence of source link lost earlier than the source IAB donor CU. The target IAB donor CU may inform the source IAB donor CU of the occurrence of source link lost through the first request acknowledgement message. Then, the source IAB donor CU may perform relevant signaling interaction with the target IAB donor CU, to transmit, to the UE served by the migrating node that has not accomplished context handover, the UE context handover command through the target IAB donor CU. On the other hand, when the source link lost occurs, the source IAB donor CU may know the occurrence of source link lost earlier than the target IAB donor CU in other manners. Then, the source IAB donor CU may perform relevant signaling interaction with the target IAB donor CU, to transmit, through the target IAB donor CU, the UE context handover command to the UE served by the migrating node that has not accomplished context handover.

In addition, if the UE context handover command is transmitted to the UE served by the migrating node that has not accomplished context handover through the target IAB donor CU, since a security key used by the UE context handover command transmitted by the target IAB donor CU is different from a security key used by the UE context handover command transmitted by the source IAB donor CU, the UE that has not accomplished context handover cannot directly decode the UE context handover command transmitted by the target IAB donor CU. Therefore, the signaling interaction between the source IAB donor CU and the target IAB donor CU may include the transmission of security key.

Based on this, the disclosure provides a variety of solutions, and these solutions will be explained below one by one.

In a first solution, the source IAB donor CU encapsulates the UE context handover command into a packet data convergence protocol protocol data unit (PDCP PDU), and then transmits the PDCP PDU to the UE through an F1-C via target path.

In one optional embodiment of the disclosure, the transmitting a UE context handover command to the UE includes:
transmitting a PDCP PDU to the UE, the PDCP PDU containing the UE context handover command.

Further, this solution further includes: receiving the PDCP PDU transmitted by the source IAB donor centralized unit.

Specifically, as shown in FIG. 6, this solution includes the following specific steps.
(1) The source IAB donor CU triggers a UE context handover, i.e., transmitting a first request message to the target IAB donor CU. The first request message may be a UE context HO request.
(2) The target IAB donor CU transmits a UE context setup request to the migrating node.
(3) The migrating node returns a UE context setup response to the target IAB donor CU.
(4) When the source link lost occurs, the migrating node will migrate an F1 termination to the target IAB donor CU. At this time, the target IAB donor CU can know the occurrence of source link lost. In this case, the target IAB donor CU transmits a first request acknowledgement message carrying first indication information to the source IAB donor CU. The first indication information contains information for indicating that the migrating node is disconnected from the source IAB donor CU, i.e., information for indicating the occurrence of source link lost. The first request acknowledgement message may be UE context HO request ACK.
(5) Upon receiving the first indication information, the source IAB donor CU can know the occurrence of source link lost and the source IAB donor CU cannot transmit the UE context modification to the UE.
(6) The source IAB donor CU encapsulates the UE context HO command into a PDCP PDU and then transmits the PDCP PDU to the target IAB donor CU.
(7) The target IAB donor CU then transmits, to the UE served by the migrating node that has not accomplished context handover, the PDCP PDU through the first F1 connection via a target path. At this time, the UE can accomplish the UE context handover. The first F1 connection via the target path refers to the F1 connection between the migrating node and the target IAB donor CU.

In a second solution, the target IAB donor CU uses a first security key of the source IAB donor CU and transmits the UE context handover command to the UE.

In one optional embodiment of the disclosure, the transmitting a UE context handover command to the UE includes:
transmitting the UE context handover command to the UE based on a first security key of the source IAB donor centralized unit.

Further, the method further includes: receiving second indication information transmitted by the source IAB donor centralized unit, the second indication information containing at least one of the first security key and information for instructing the target IAB donor centralized unit to transmit the UE context handover command to the UE based on the first security key.

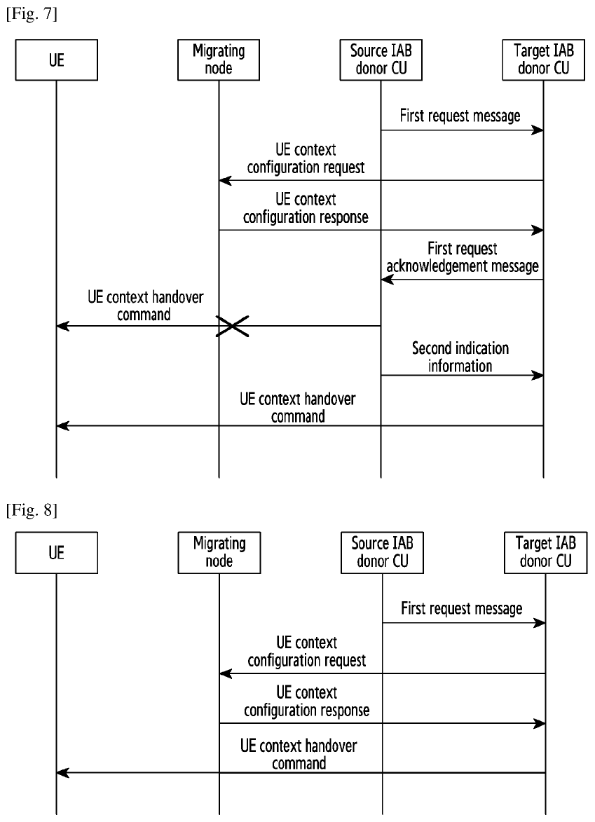

Specifically, as shown in FIG. 7, this solution includes the following specific steps.
(1) The source IAB donor CU triggers a UE context handover, i.e., transmitting a first request message to the target IAB donor CU.
(2) The target IAB donor CU transmits a UE context setup request to the migrating node.
(3) The migrating node returns a UE context setup response to the target IAB donor CU.
(4) When the source link lost occurs, the migrating node will migrate an F1 donor to the target IAB donor CU. At this time, the target IAB donor CU can know the occurrence of source link lost. In this case, the target IAB donor CU transmits a first request acknowledgement message carrying first indication information to the source IAB donor CU. The first indication information contains information for indicating that the migrating node is disconnected from the source IAB donor CU, i.e., information for indicating the occurrence of source link lost.
(5) Upon receiving the first indication information, the source IAB donor CU can know the occurrence of source link lost and the source IAB donor CU cannot transmit the UE context modification (UE context handover command) to the UE.
(6) The source IAB donor CU transmits second indication information to the target IAB donor CU through an Xn interface. The second indication information contains the following information:
a) the first security key of the source IAB donor CU;
b) information for instructing the target IAB donor CU to transmit the UE context handover command to the UE served by the migrating node by using the first key of the source IAB donor CU; and
c) in addition to the first security key of the source IAB donor CU, the packet data convergence protocol sequence number (PDCP SN) and hyper frame number (HFN) being used by the target IAB donor CU.
(7) Upon receiving the second indication information, the target IAB donor CU directly transmits, to the UE served by the migrating node that has not accomplished context handover, the UE context handover command by using the first key, PDCP SN and HFN transmitted by the source IAB donor CU.

The third solution is another case where the target IAB donor CU uses a first security key of the source IAB donor CU to transmit a UE context handover command to the UE.

In one optional embodiment of the disclosure, the transmitting a UE context handover command to the UE includes:
transmitting the UE context handover command to the UE based on a first security key of the source IAB donor centralized unit.

The first request message carries third indication information, and the third indication information contains at least one of:
information for indicating that the migrating node is disconnected from the source IAB donor centralized unit;
the first security key; and
information for instructing the target IAB donor centralized unit to transmit the UE context handover command to the UE based on the first security key.

Specifically, the source IAB donor CU knows the occurrence of source link lost earlier than the target IAB donor CU, the source IAB donor CU, by adding the third indication information in the first request message, informs the target IAB donor CU of the occurrence of source link lost and instructs the target IAB donor CU to transmit the UE context handover command based on the first security key.

Specifically, as shown in FIG. 8, this solution includes the following specific steps.
(1) After being aware of the source link lost, the source IAB donor node directly adds the third indication information in the first request message and then transmits the first request message to the target IAB donor CU. The third indication information contains the following information:
a) information for indicating that the migrating node is disconnected from the source IAB donor centralized unit, i.e., information for indicating the occurrence of source link lost;
b) the first security key of the source IAB donor CU, PDCP SN and HFN; and
c) information for instructing the target IAB donor CU to directly transmit the UE context handover command to the UE served by the migrating node based on the first security key.
(2) The target IAB donor CU transmits a UE context setup request to the migrating node.
(3) The migrating node returns a UE context setup response to the target IAB donor CU.
(4) Upon receiving the UE context setup response, the target IAB donor CU directly transmits, to the UE served by the migrating node that has not accomplished context handover, the UE context handover command by using the first key, PDCP SN and HFN transmitted by the source IAB donor CU.

In one optional embodiment of the disclosure, the method further includes:
receiving a third request message carrying third indication information transmitted by the source IAB donor centralized unit, the third request message being configured for requesting for UE context handover;
wherein the third indication information contains at least one of:
information for indicating that the migrating node is disconnected from the source IAB donor centralized unit;
the first security key; and
information for instructing the target IAB donor centralized unit to transmit the UE context handover command to the UE based on the first security key.

The third request message may be a UE context HO request.

Specifically, compared with the solution in FIG. 8, the source IAB donor CU knows the occurrence of source link lost earlier than the target IAB donor CU. More specifically, the source IAB donor CU knows the occurrence of source link lost after transmitting the first request message. Thus, the source IAB donor CU adds the third indication information in the third request message, instead of adding the third indication information in the first request message. That is, by adding the third indication information in the third request message, the source IAB donor CU informs the target IAB donor CU of the occurrence of source link lost and instructs the target IAB donor CU to transmit the UE context handover command based on the first security key.

In the fourth solution, the target IAB donor CU triggers the target IAB donor DU to temporarily establish a second F1 connection (new logical F1 connection) with the source IAB donor CU, the source IAB donor CU transmits the UE context handover command to the target IAB donor DU through the second F1 connection, and the target IAB donor DU transmits the UE context handover command to the UE through the first F1 connection via the target path.

Specifically, in one optional embodiment of the disclosure, the transmitting a UE context handover command to the UE includes:
transmitting the UE context handover command to the UE through the target IAB donor distributed unit.

The first request acknowledgement message further carries fourth indication information, and the fourth indication information is configured for indicating information of establishment of the second F1 connection between the source IAB donor centralized unit and the corresponding target IAB donor distributed unit.

Further, the method further includes: transmitting fifth indication information to the corresponding target IAB donor distributed unit;
wherein the fifth indication information contains at least one of:
trigger information for the target IAB donor distributed unit to establish the second F1 connection with the source IAB donor centralized unit; and
a mapping relationship between the second F1 connection and the first F1 connection, the first F1 connection being an F1 connection between the migrating node and the target IAB donor centralized unit.

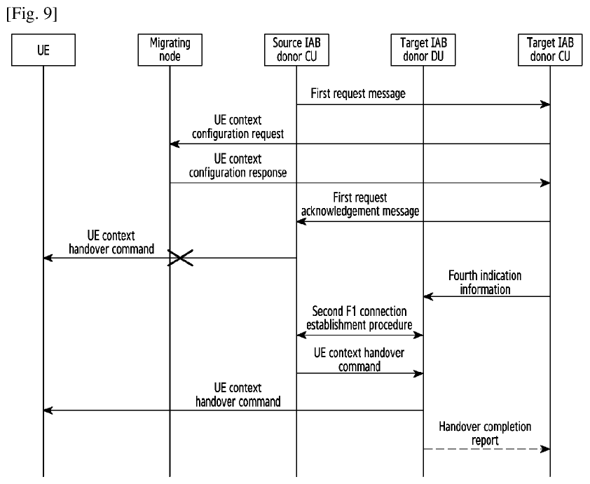

Specifically, as shown in FIG. 9, this solution includes the following specific steps.
(1) The source IAB donor CU triggers a UE context handover, i.e., transmitting a first request message to the target IAB donor CU.
(2) The target IAB donor CU transmits a UE context setup request to the migrating node.
(3) The migrating node returns a UE context setup response to the target IAB donor CU.
(4) If the target IAB donor CU is aware of occurrence of source link lost, the target IAB donor CU transmits a first request acknowledgement message carrying fourth indication information to the source IAB donor CU, wherein the fourth indication information contains the following information:
a) information for indicating the occurrence of source link lost; and
b) information for instructing the source IAB donor CU to establish the second F1 connection (new logical F1 connection) with the target IAB donor DU.
(5) Upon receiving the fourth indication information, the source IAB donor CU knows the occurrence of source link lost.
(6) The target IAB donor CU transmits fifth indication information to the target IAB donor DU. The fifth indication information includes the following information:
a) trigger information for the target IAB donor DU to establish the second F1 connection with the source IAB donor CU; and
b) the mapping relationship between the second F1 connection and the first F1 connection in the target path.
(7) Upon receiving the fifth indication information, the target IAB donor DU initiates a second F1 connection establishment procedure to the source IAB donor CU, including:
a) The target IAB donor DU transmits a second F1 connection establishment request to the source IAB donor CU.
b) The source IAB donor CU returns a second F1 connection establishment response to the target IAB donor DU.
(8) After the second F1 connection is established, the source IAB donor CU transmits the UE context handover command, which has not been transmitted, to the target IAB donor DU through the second F1 connection.
(9) The target IAB donor DU maps the UE context handover command from the second F1 connection to the first F1 connection in the target path, and transmits the UE context handover command transmitted by the source IAB donor CU to the UE through the first F1 connection in the target path.
(10) Optionally, after the target IAB donor DU transmits the UE context handover command to the UE, the target IAB donor DU transmits the corresponding handover completion report to the target IAB donor CU, so that the target IAB donor CU knows that the UE context handover has been accomplished.

In the fifth solution, the source IAB donor CU modifies the security key used by the UE served by the migrating node, so that the target IAB donor CU can directly use its own second key to transmit the UE context handover command to the UE when the source link lost occurs.

In one optional embodiment of the disclosure, the method further includes:
receiving a fourth request message transmitted by the source IAB donor centralized unit, the fourth request message being configured for requesting the second security key to the target IAB donor centralized unit; and
transmitting a second request acknowledgement message to the source IAB donor centralized unit, the second request acknowledgement message carrying the second security key, so that the source IAB donor centralized unit transmits sixth indication information to the UE, the sixth indication information being configured for instructing the UE to update the used security key based on the second security key.

The sixth indication information contains at least one of:
information for instructing the UE to update the used security key into the second security key when the migrating node is migrated to the target IAB donor centralized unit; and
information for instructing the UE to immediately update the used security key into the second security key.

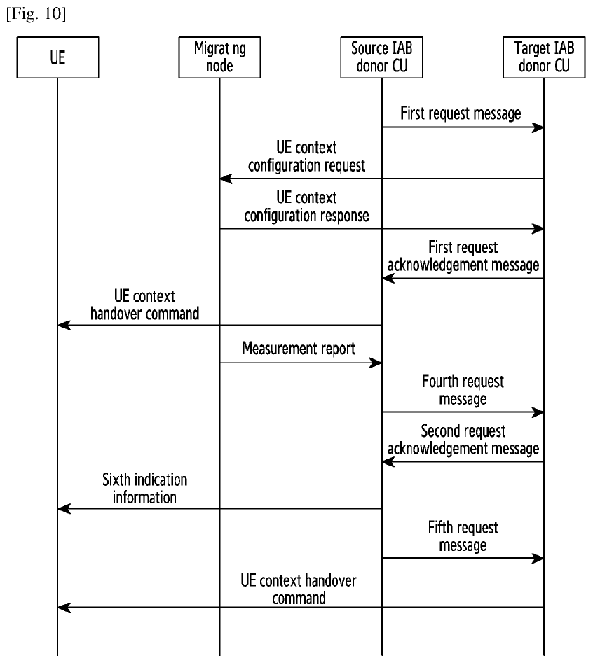

Specifically, as shown in FIG. 10, this solution includes the following specific steps.
(1) The source IAB donor CU triggers a UE context handover, i.e., transmitting a first request message to the target IAB donor CU.
(2) The target IAB donor CU transmits a UE context setup request to the migrating node.
(3) The migrating node returns a UE context setup response to the target IAB donor CU.
(4) The target IAB donor CU returns a first request acknowledgement message (not containing the first indication information) to the source IAB donor CU.
(5) The source IAB donor CU transmits a UE context handover command to the UE.
(6) At the same time, the migrating node transmits a measurement report to the source IAB donor CU.
(7) When the source IAB donor CU is aware of, according to the measurement report, that the quality of the source link is degraded, the source IAB donor CU transmits a fourth request message to the target IAB donor CU to request the second security key from the target IAB donor CU. The fourth request message may be a security key request (request target IAB donor CU's key).
(8) Upon receiving the security key request information, the target IAB donor CU feeds a second request acknowledgement message back to the source IAB donor CU. The second request acknowledgement message contains the second security key. In addition, a new information element (IE) may be set for the second security request information.
(9) Upon receiving the reply from the target IAB donor CU, the source IAB donor CU transmits, to the UE that has not accomplished context handover, sixth indication information through a downlink RRC signaling. The sixth indication information contains the following information:
a) the second security key; and
b) information for instructing the UE that has not accomplished context handover to update the used security key.

Optionally, the source IAB donor CU may first transmit the second security key to the UE, and the UE modifies the used security key after the migrating node is migrated to the target IAB donor CU, instead of update the used security key immediately.

After the migrating node is migrated to the target IAB donor CU, the indication information may be transmitted to inform the UE. The UE may also know that the migrating node is migrated to the target IAB donor CU by other manners, and the specific methods will not be limited in the disclosure.
(10) The source IAB donor CU transmits a fifth request message to the target IAB donor CU to instruct the target IAB donor CU to directly transmit the UE context handover command to the UE that has not accomplished context handover by using its own second security key. The fifth request message may be a UE context HO command request.
(11) The target IAB donor CU directly transmits the UE context handover command to the UE based on the second security key, to hand over the context of the UE.

In one optional embodiment of the disclosure, the method further includes:
configuring a reference signal receiving power/reference signal receiving quality (RSRP/RSRQ) threshold for the migrating node.

In the sixth solution, in order to avoid the occurrence of source link lost, the source IAB donor CU makes two preparations in advance.

Specifically, in one optional embodiment of the disclosure, the method further includes:
configuring an RSRP/RSRQ threshold for the migrating node;
receiving an event report transmitted by the migrating node when the measured RSRP/RSRQ of a source parent IAB node is not larger than the RSRP/RSRQ threshold; and
in response to the event report, performing partial migration for migrating node.

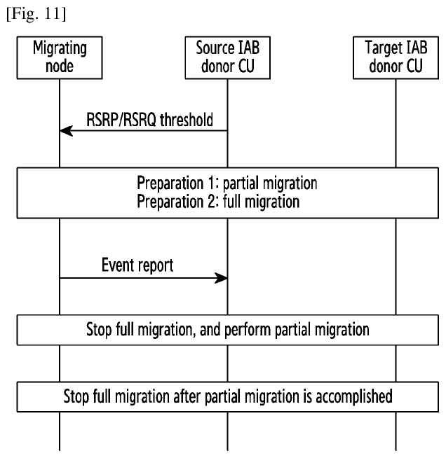

Specifically, as shown in FIG. 11, this solution includes the following specific steps.
(1) The source IAB donor CU configures an RSRP/RSRQ threshold for the migrating node and transmits it to the migrating node.

The setting of the RSRP/RSRQ threshold should consider that there is enough time for the migrating node to complete partial migration.
(2) When the source IAB donor CU predicts that the migrating node will be migrated to the target IAB donor CU, two preparations are made.
a) Preparation 1: the configuration related to partial migration is prepared in advance, including all configuration information related to partial migration, such as the backhaul radio link control channel (BH RLC channel), backhaul adaption protocol (BAP) address and mapping.
b) Preparation 2: the configuration related to full migration is prepared in advance, including all configuration information related to full migration, such as F1-C configuration and UE context handover configuration.
(3) When the migrating node is aware of that the measured RSRP/RARQ value of the source parent IAB node is less than the RSRP/RSRQ threshold, the migrating node reports the event report to the source IAB donor CU.
(4) Upon receiving the event report, the source IAB donor CU stops preparing full migration, and directly triggers the migrating node to perform partial migration.
(5) After the partial migration has been accomplished, the migrating node may further perform full migration as needed.

It is to be noted that the preparation 1 is easier and faster than the preparation 2. The preparation 1 is first established to avoid the occurrence of source link lost during the establishment of the preparation 2. This solution is applicable to a scenario where the performance of the source link is degraded during or before the F1-C establishment procedure in Pre-preparation.

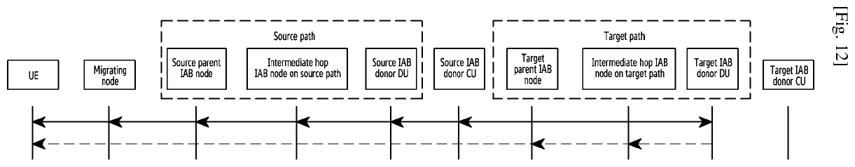

In addition, the dual active protocol stack (DAPS) is proposed to solve the delay problem caused by data interruption during the base station handover procedure for the UE. By applying the DAPS technology, almost Oms handover during the base station handover procedure can be realized for the UE. However, the IAB scenario is different from the commonly considered scenarios. That is, if the source IAB donor CU transmits downlink data to the source IAB donor DU and the target IAB donor DU, during the DAPS handover process, the UE needs to receive the downlink data simultaneously from the source path and the target path. If the difference between the numbers of IAB nodes respectively corresponding to the target path and the source path is too large, there will be a large time difference until the UE receives all downlink data of the source path and the target path, respectively, so that the UE's delay in de-duplication and sequencing of the PDCP layer is increased, as shown in FIG. 12. Since the UE directly receives the downlink data from two connected base stations when the DAPS is applied in a general scenario, and there are no intermediate multiple hop nodes like in the IAB network, this problem is not serious as that when the DAPS is applied in the IAB scenario.

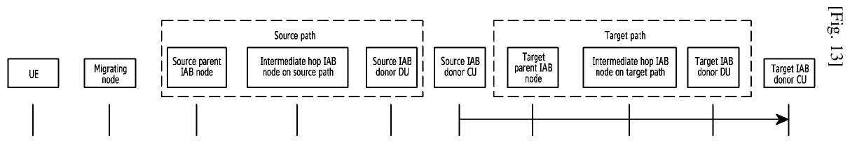

Therefore, in the solution of the disclosure, when the source IAB donor CU decides to allow the migrating node to apply the DAPS during the migration procedure, the source IAB donor CU adds assistance information in the UE context HO request and transmits the UE context HO request to the target IAB donor CU, as shown in FIG. 13. The assistance information may include:
the number of multiple hop nodes to migrating node in the source path; and
the time threshold used for that the source IAB donor CU expects to transmit downlink data to the UE through the target path, where the threshold may be optionally the maximum time threshold that the source IAB donor CU can bear;
further, the target IAB donor CU selects, according to the assistance information, the appropriate target path configuration for the migrating node to perform DAPS.

An embodiment of the disclosure further provides a method performed by a source IAB donor centralized unit in a communication system, including:

Step S201: transmitting a first request message to a target IAB donor centralized unit, the first request message being configured for requesting for UE context handover, so that the target IAB donor centralized unit transmits a UE context handover command to a UE.

Similarly, the method provided in the embodiment of the disclosure corresponds to the method in the embodiments on the target IAB donor centralized unit side, and the detailed functional descriptions and the achieved beneficial effects can specifically refer to the above descriptions of the corresponding method in the embodiments on the target IAB donor centralized unit side and will not be repeated here.

An embodiment of the disclosure provides a target IAB donor centralized unit. The target IAB donor centralized unit may specifically include a first request message receiving module and a UE context handover command transmitting module, wherein
the first request message receiving module is configured to receive a first request message transmitted by a source IAB donor centralized unit, the first request message being configured for requesting for UE context handover; and
the UE context handover command transmitting module is configured to transmit a UE context handover command to a UE.

Optionally, the target IAB donor centralized unit further includes a first request acknowledgement message transmitting module configured to:
transmit a first request acknowledgement message carrying first indication information to the source IAB donor centralized unit, the first indication information containing information for indicating that a migrating node is disconnected from the source IAB donor centralized unit.

Optionally, the target IAB donor centralized unit further includes a second request message receiving module configured to:
receive a second request message transmitted by the migrating node, the second request message being configured for requesting for migration of the migrating node to the target IAB donor centralized unit.

Optionally, the UE context handover command transmitting module is specifically configured to:
transmit a PDCP PDU to the UE, the PDCP PDU containing the UE context handover command.

Optionally, the target IAB donor centralized unit further includes a PDCP PDU receiving module configured to:
receive the PDCP PDU transmitted by the source IAB donor centralized unit.

Optionally, the UE context handover command transmitting module is specifically configured to:
transmit the UE context handover command to the UE based on a first security key of the source IAB donor centralized unit.

Optionally, the target IAB donor centralized unit further includes a second indication information receiving module configured to:
receive second indication information transmitted by the source IAB donor centralized unit, the second indication information containing at least one of the first security key and information for instructing the target IAB donor centralized unit to transmit the UE context handover command to the UE based on the first security key.

Optionally, the first request message carries third indication information;
wherein the third indication information contains at least one of:
information for indicating that the migrating node is disconnected from the source IAB donor centralized unit;
the first security key; and
information for instructing the target IAB donor centralized unit to transmit the UE context handover command to the UE based on the first security key.

Optionally, the target IAB donor centralized unit further includes a third request message receiving module configured to:
receive a third request message carrying third indication information transmitted by the source IAB donor centralized unit, the third request message being configured for requesting for UE context handover;
wherein the third indication information contains at least one of:
information for indicating that the migrating node is disconnected from the source IAB donor centralized unit;
the first security key; and
information for instructing the target IAB donor centralized unit to transmit the UE context handover command to the UE based on the first security key.

Optionally, the first request acknowledgement message further carries fourth indication information, and the fourth indication information is configured for instructing the source IAB donor centralized unit to establish a second F1 connection with a corresponding target IAB donor distributed unit.

Optionally, the UE context handover command transmitting module is specifically configured to:
transmit the UE context handover command to the UE through the target IAB donor distributed unit.

Optionally, the target IAB donor centralized unit further includes a fifth indication information receiving module configured to:
transmit fifth indication information to the corresponding target IAB donor distributed unit;
wherein the fifth indication information contains at least one of:
trigger information for the target IAB donor distributed unit to establish the second F1 connection with the source IAB donor centralized unit; and
a mapping relationship between the second F1 connection and the first F1 connection, the first F1 connection being an F1 connection between the migrating node and the target IAB donor centralized unit.

Optionally, the UE context handover command transmitting module is specifically configured to:
transmit the UE context handover command to the UE based on a second security key of the target IAB donor centralized unit.

Optionally, the target IAB donor centralized unit further includes a fourth request message receiving module configured to:
receive a fourth request message transmitted by the source IAB donor centralized unit, the fourth request message being configured for requesting the second security key from the target IAB donor centralized unit; and
transmit a second request acknowledgement message to the source IAB donor centralized unit, the second request acknowledgement message carrying the second security key, so that the source IAB donor centralized unit transmits sixth indication information to the UE, the sixth indication information being configured for instructing the UE to update the used security key based on the second security key.

Optionally, the sixth indication information contains at least one of the following:
information for instructing the UE to update the used security key into the second security key when the migrating node is migrated to the target IAB donor centralized unit; and
information for instructing the UE to immediately update the used security key into the second security key.

An embodiment of the disclosure provides a source IAB donor centralized unit. The source IAB donor centralized unit specifically includes a first request message transmitting module, wherein:
the source IAB donor centralized unit is configured to transmit a first request message to a target IAB donor centralized unit, the first request message being configured for requesting for UE context handover, so that the target IAB donor centralized unit transmits a UE context handover command to a UE.

Optionally, the source IAB donor centralized unit further includes an event report module configured to:
configure an RSRP/RSRQ threshold for a migrating node;
receive an event report transmitted by the migrating node when a measured RSRP/RSRQ of a source parent IAB node is not larger than the RSRP/RSRQ threshold; and
in response to the event report, performing partial migration for migrating node.

The target IAB donor centralized unit and the source IAB donor centralized unit provided in the embodiments of the disclosure can execute the methods provided in the embodiments of the disclosure, and the implementation principles thereof are similar. The acts executed by the modules in the target IAB donor centralized unit and the source IAB donor centralized unit provided in the embodiment of the disclosure correspond to the steps in the methods provided in the embodiments of the disclosure. The detailed functional descriptions of the modules in the target IAB donor centralized unit and the source IAB donor centralized unit and the achieved beneficial effects can refer to the descriptions of the corresponding methods described above and will not be repeated here.

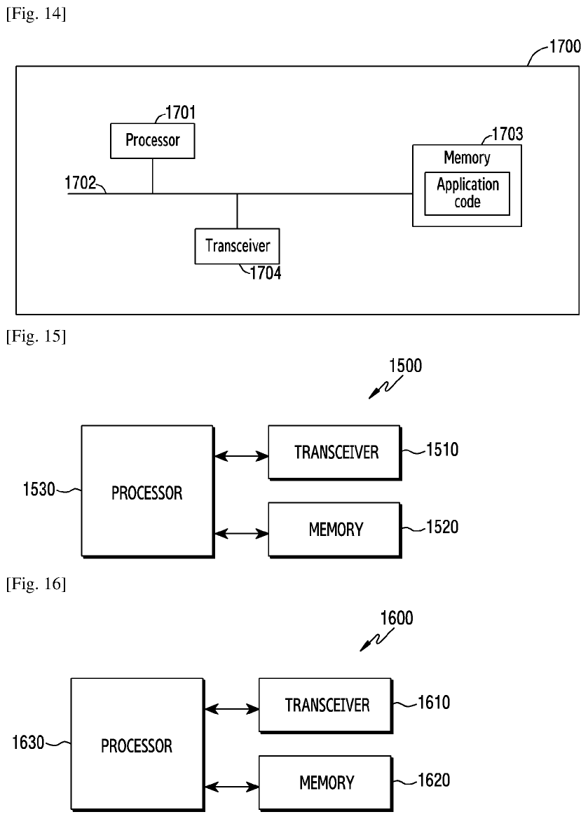

In an embodiment of the disclosure, an electronic device is provided, including: a transceiver configured to transmitting and receiving signals; and a processor coupled to the transceiver, the processor being configured to control to implement the steps of the foregoing method embodiments. Optionally, the electronic device may be a target IAB donor CU(centralized unit), and the processor in the electronic device is configured to control to implement the steps of the methods performed by the target IAB donor CU provided in the foregoing method embodiments. Optionally, the electronic device may be a source IAB donor CU(centralized unit), and the processor in the electronic device is configured to control to implement the steps of the method performed by the source IAB donor CU provided in the foregoing method embodiments. In an optional embodiment, an electronic device is provided, as shown in FIG. 14. As shown in FIG. 14, the electronic device 1700 shown in FIG. 14 includes a processor 1701 and a memory 1703. The processor 1701 is connected to the memory 1703, for example, through a bus 1702. Optionally, the electronic device 1700 may further include a transceiver 1704 configured for data interaction between the electronic device and other electronic devices (for example, transmission and/or reception of data). It should be noted that, in practical applications, the transceiver 1704 is not limited to one, and the structure of the electronic device 1700 does not constitute any limitations to the embodiments of the disclosure.

The transceiver 1704 collectively refers to a network entity receiver and a network entity transmitter, and may transmit/receive a signal to/from a base station or a UE. The signal transmitted or received to or from the base station or the UE may include control information and data. In this regard, the transceiver 1704 may include an RF transmitter for up-converting and amplifying a frequency of a transmitted signal, and an RF receiver for amplifying low-noise and down-converting a frequency of a received signal. However, this is only an example of the transceiver 1704 and components of the transceiver 1704 are not limited to the RF transmitter and the RF receiver.

The transceiver 1704 may receive and output, to the processor 1701, a signal through a wireless channel, and transmit a signal output from the processor 1701 through the wireless channel.

The processor 1701 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute various exemplary logical blocks, modules and circuits described in connection with the present disclosure. The processor 1701 may also be a combination for realizing computing functions, for example, a combination of one or more microprocessors, a combination of a DSP and a microprocessor, etc.

The processor 1701 may control a series of processes such that the network entity operates as described above. For example, the transceiver 1704 may receive a data signal including a control signal, and the processor 1701 may determine a result of receiving the data signal.

The bus 1702 may include a path to transfer information between the components described above. The bus 1702 may be a peripheral component interconnect (PCI) bus, or an extended industry standard architecture (EISA) bus, etc. The bus 1702 may be an address bus, a data bus, a control bus, etc. For ease of presentation, the bus is rep-resented by only one thick line in FIG. 8. However, it does not mean that there is only one bus or one type of buses.

The memory 1703 may be read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that can carry or store computer programs and that can be accessed by computers, which is not limited herein.

The memory 1703 may store a program and data required for operations of the network entity. Also, the memory 1703 may store control information or data included in a signal obtained by the network entity. The memory 1703 may be a storage medium, such as a ROM, a RAM, a hard disk, a CD-ROM, and a DVD, or a combination of storage media.

The memory 1703 is used to store computer programs for executing the embodiments of the disclosure, and is controlled by the processor 1701. The processor 1701 is used to execute the computer programs stored in the memory 1703 to implement the steps shown in the above method embodiments.

FIG. 15 illustrates a structure of a base station according to an embodiment of the disclosure.

As shown in FIG. 15, the base station according to an embodiment may include a transceiver 1510, a memory 1520, and a processor 1530. The transceiver 1510, the memory 1520, and the processor 1530 of the base station may operate according to a communication method of the base station described above. However, the components of the base station are not limited thereto. For example, the base station may include more or fewer components than those described above. In addition, the processor 1530, the transceiver 1510, and the memory 1520 may be implemented as a single chip. Also, the processor 1530 may include at least one processor. Furthermore, the base station of FIG. 15 corresponds to the base station in embodiments of other Figures described above.

The transceiver 1510 collectively refers to a base station receiver and a base station transmitter, and may transmit/receive a signal to/from a terminal(UE) or a network entity. The signal transmitted or received to or from the terminal or a network entity may include control information and data. The transceiver 1510 may include a RF transmitter for up-converting and amplifying a frequency of a transmitted signal, and a RF receiver for amplifying low-noise and down-converting a frequency of a received signal. However, this is only an example of the transceiver 1510 and components of the transceiver 1510 are not limited to the RF transmitter and the RF receiver.

Also, the transceiver 1510 may receive and output, to the processor 1530, a signal through a wireless channel, and transmit a signal output from the processor 1530 through the wireless channel.

The memory 1520 may store a program and data required for operations of the base station. Also, the memory 1520 may store control information or data included in a signal obtained by the base station. The memory 1520 may be a storage medium, such as read-only memory (ROM), random access memory (RAM), a hard disk, a CD-ROM, and a DVD, or a combination of storage media.

The processor 1530 may control a series of processes such that the base station operates as described above. For example, the transceiver 1510 may receive a data signal including a control signal transmitted by the terminal, and the processor 1530 may determine a result of receiving the control signal and the data signal transmitted by the terminal.

FIG. 16 illustrates a structure of a UE according to an embodiment of the disclosure.

As shown in FIG. 16, the UE according to an embodiment may include a transceiver 1610, a memory 1620, and a processor 1630. The transceiver 1610, the memory 1620, and the processor 1630 of the UE may operate according to a communication method of the UE described above. However, the components of the UE are not limited thereto. For example, the UE may include more or fewer components than those described above. In addition, the processor 1630, the transceiver 1610, and the memory 1620 may be implemented as a single chip. Also, the processor 1630 may include at least one processor. The UE of FIG. 16 corresponds to the UE in embodiments of other Figures described above. The UE of FIG. 16 may correspond to a source IAB donor centralized unit(CU), a target IAB donor centralized unit(CU) or a target IAB donor distributed unit in embodiments of this disclosure.

The transceiver 1610 collectively refers to a UE receiver and a UE transmitter, and may transmit/receive a signal to/from a base station or a network entity. The signal transmitted or received to or from the base station or a network entity may include control information and data. The transceiver 1610 may include a RF transmitter for up-converting and amplifying a frequency of a transmitted signal, and a RF receiver for amplifying low-noise and down-converting a frequency of a received signal. However, this is only an example of the transceiver 1610 and components of the transceiver 1610 are not limited to the RF transmitter and the RF receiver.

Also, the transceiver 1610 may receive and output, to the processor 1630, a signal through a wireless channel, and transmit a signal output from the processor 1630 through the wireless channel.

The memory 1620 may store a program and data required for operations of the UE. Also, the memory 1620 may store control information or data included in a signal obtained by the UE. The memory 1620 may be a storage medium, such as read-only memory (ROM), random access memory (RAM), a hard disk, a CD-ROM, and a DVD, or a combination of storage media.

The processor 1630 may control a series of processes such that the UE operates as described above. For example, the transceiver 1610 may receive a data signal including a control signal transmitted by the base station or the network entity, and the processor 1630 may determine a result of receiving the control signal and the data signal transmitted by the base station or the network entity.

Embodiments of the disclosure provide a computer-readable storage medium having a computer program stored on the computer-readable storage medium, the computer program, when executed by a processor, implements the steps and corresponding contents of the foregoing method embodiments.

Embodiments of the disclosure also provide a computer program product including a computer program, the computer program when executed by a processor realizing the steps and corresponding contents of the preceding method embodiments.

The terms “first”, “second”, “third”, “fourth”, “1”, “2”, etc. (if present) in the specification and claims of this application and the accompanying drawings above are used to distinguish similar objects and need not be used to describe a particular order or sequence. It should be understood that the data so used is interchangeable where appropriate so that embodiments of the disclosure described herein can be implemented in an order other than that illustrated or described in the text.

It should be understood that while the flow diagrams of embodiments of the present disclosure indicate the individual operational steps by arrows, the order in which these steps are performed is not limited to the order indicated by the arrows. Unless explicitly stated herein, in some implementation scenarios of embodiments of the present disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the present disclosure are not limited thereto.

The foregoing is merely an optional implementation of some implementation scenarios of the disclosure. It should be noted that, for a person of ordinary skill in the art, other similar implementation means based on the technical concepts of the disclosure are used without departing from the technical concepts of the solutions of the disclosure, and also belong to the scope of protection of the embodiments of the disclosure. Those skilled in the art will understand that the various illustrative logical blocks, modules, circuits, and steps described in this disclosure may be implemented as hardware, software, or a combination of both. To clearly illustrate this inter-changeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this disclosure.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors co-operating with a DSP core, or any other such configuration.

The steps of the method or algorithm described in this disclosure may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method performed by a target IAB donor centralized unit in a wireless communication system, the method comprising:
receiving a first request message transmitted by a source IAB donor centralized unit, the first request message for requesting for UE context handover; and
transmitting a UE context handover command to a user equipment (UE).

2. The method of claim 1, further comprising:
transmitting a first request acknowledgement message including first indication information to the source IAB donor centralized unit, the first indication information including information for indicating that a migrating node is disconnected from the source IAB donor centralized unit.

3. The method of claim 2, further comprising:
receiving a second request message transmitted by the migrating node, the second request message for requesting for migration of the migrating node to the target IAB donor centralized unit.

4. The method of claim 1, wherein the transmitting a UE context handover command to a UE comprises:
transmitting a packet data convergence protocol protocol data unit (PDCP PDU) to the UE, the PDCP PDU including the UE context handover command.

5. The method of claim 4, further comprising:
receiving the PDCP PDU transmitted by the source IAB donor centralized unit.

6. The method of claim 1, wherein the transmitting a UE context handover command to a UE comprises:
transmitting the UE context handover command to the UE based on a first security key of the source IAB donor centralized unit.

7. The method of claim 6, further comprising:
receiving second indication information transmitted by the source IAB donor centralized unit, the second indication information including at least one of the first security key and information for instructing the target IAB donor centralized unit to transmit the UE context handover command to the UE based on the first security key.

8. The method of claim 6, wherein the first request message includes third indication information;
wherein the third indication information includes at least one of:
information for indicating that a migrating node is disconnected from the source IAB donor centralized unit;
the first security key; and
information for instructing the target IAB donor centralized unit to transmit the UE context handover command to the UE based on the first security key.

9. The method to-of claim 6, further comprising:
receiving a third request message including third indication information transmitted by the source IAB donor centralized unit, the third request message for requesting for UE context handover;
wherein the third indication information includes at least one of:
information for indicating that a migrating node is disconnected from the source IAB donor centralized unit;
the first security key; and
information for instructing the target IAB donor centralized unit to transmit the UE context handover command to the UE based on the first security key.

10. The method of claim 2, wherein the first request acknowledgement message further includes fourth indication information, and the fourth indication information for instructing the source IAB donor centralized unit to establish a second F1 connection with a corresponding target IAB donor distributed unit.

11. The method of claim 10, wherein the transmitting a UE context handover command to a UE comprises:
transmitting the UE context handover command to the UE through the target IAB donor distributed unit,
transmitting fifth indication information to the corresponding target IAB donor distributed unit;
wherein the fifth indication information includes at least one of:
trigger information for the target IAB donor distributed unit to establish the second F1 connection with the source unit; and
a mapping relationship between the second F1 connection and a first F1 connection, the first F1 connection being an F1 connection between the migrating node and the target unit.

12. The method of claim 1, wherein the transmitting a UE context handover command to a UE comprises:
transmitting the UE context handover command to the UE based on a second security key of the target IAB donor centralized unit.

13. The method of claim 12, further comprising:
receiving a fourth request message transmitted by the source IAB donor centralized unit, the fourth request message for requesting the second security key from the target IAB donor centralized unit; and
transmitting a second request acknowledgement message to the source IAB donor centralized unit, the second request acknowledgement message including the second security key, so that the source IAB donor centralized unit transmits sixth indication information to the UE, the sixth indication information for instructing the UE to update a used security key based on the second security key,
wherein the sixth indication information includes at least one of:
information for instructing the UE to update the used security key into the second security key when a migrating node is migrated to the target unit; and
information for instructing the UE to immediately update the used security key into the second security key.

14. A method performed by a source IAB donor centralized unit in a wireless communication system, the method comprising:
transmitting a first request message to a target IAB donor centralized unit, the first request message for requesting for UE context handover, so that the target IAB donor centralized unit transmits a UE context handover command to a UE.

15. The method of claim 14, further comprising:
configuring a reference signal receiving power/reference signal receiving quality (RSRP/RSRQ) threshold for a migrating node;
receiving an event report transmitted by the migrating node when a measured RSRP/RSRQ of a source parent IAB node is not larger than the RSRP/RSRQ threshold; and
in response to the event report, performing partial migration for migrating node.
